(19) United States
(12) Patent Application Publication
(10) Pub. No.: US 2018/0043618 A1
(43) Pub. Date: Feb. 15, 2018

(54) EMBEDDING APPARATUS AND METHOD UTILIZING ADDITIVE MANUFACTURING

(71) Applicant: The Board of Regents, The University of Texas System, Austin, TX (US)

(72) Inventors: Corey Shemelya, El Paso, TX (US); David Espalin, El Paso, TX (US); Eric MacDonald, El Paso, TX (US); Ryan Wicker, El Paso, TX (US)

(21) Appl. No.: 15/555,468

(22) PCT Filed: Feb. 29, 2016
(86) PCT No.: PCT/US16/20055

§ 371 Date: Sep. 1, 2017

Related U.S. Application Data
(60) Provisional application No. 62/127,035, filed on Mar. 2, 2015.

(51) Int. Cl. B29C 64/314; B33Y 70/00; B33Y 30/00; B29C 64/112; B33Y 10/00

(52) U.S. Cl. CPC B29C 64/314; B29C 64/112; B33Y 10/00; B33Y 30/00; B33Y 70/00; B29K 2069/00

(57) ABSTRACT

An embedded material and an embedding apparatus and method. A compatible solute can be dissolved in a solvent. The object to be embedded can be coated with the solvent/plastic solution using, for example, addition and/or condensation polymerization. The solvent can be removed. The coated object can be inserted, snap fit, or submerged into a partially 3D printed substrate with or without the aid of ultrasonic embedding, thermal energy, joule heating, and/or the use of adhesives, and the 3D printing process resumes in order to fully embed the coated object within the 3D printed substrate. The coated object can be inserted, snap fit, or submerged into a partially 3D printed substrate with or without the addition of ultrasonic embedding, thermal energy, joule heating, and/or adhesives, and the 3D printing process resumes in order to fully embed the coated object within the 3D printed substrate.

### RELATED APPLICATION

This application claims the benefit of Patent Cooperation Treaty International Application Number PCT/US16/20055, filed Feb. 29, 2016, and entitled “EMBEDDING APPARATUS AND METHOD UTILIZING ADDITIVE MANUFACTURING” which claims Provisional Application No. 62/127,035 filed Mar. 2, 2015, and entitled “EMBEDDING APPARATUS AND METHOD.”

### BACKGROUND INFORMATION

### 1. Field:

Embodiments generally relate to the manufacture of 3D structures and 3D structural electronic, electromagnetic, and electromechanical components through the use of Additive Manufacturing (also known as 3D Printing, Layer Manufacturing, Rapid Manufacturing, and Direct Digital Manufacturing). Embodiments also relate to techniques and configurations for increasing the environmental durability of such components. Embodiments additionally relate to electronic, electromagnetic, and electromechanical components having an interfacial buffer for differences in coefficients of thermal expansion. Embodiments further relate to components (e.g., wires, meshes, foils, sheets, and other preformed materials) utilized in plastic components for such devices.

### 2. Background:

The next generation of manufacturing technology will require complete spatial control of material and functionality as structures are created layer-by-layer—providing fully customizable, high value, multi-functional products for the consumer, biomedical, aerospace, and defense industries. With contemporary Additive Manufacturing (AM - also known more popularly as 3D printing) providing the base fabrication process, a comprehensive manufacturing suite will be integrated seamlessly to include: 1) extrusion of a wide variety of robust thermoplastics/metals; 2) micromachining; 3) laser ablation; 4) embedding of wires, metal surfaces, and fine-pitch meshes submerged within the thermoplastics; 5) micro-dispensing; and 6) robotic component placement.

Collectively, the integrated technologies will fabricate multi-material structures through the integration of multiple integrated manufacturing systems (multi-technology) to provide multi-functional products (consumer wearable electronics, bio-medical devices, defense, space and energy systems, etc.). Paramount to this concept is the embedding of highly conductive and densely routed traces and surfaces within the 3D printed dielectric structures with improved adhesion and without being compromised by oxidation. Embedding can take place on a planar or curved surface.

The apparatus and method described in this work is aimed at improving aspects of Additive Manufacturing (AM), commonly known as 3D printing (also known as rapid prototyping, direct digital manufacturing, layered manufacturing, and additive fabrication). Additive manufacturing is defined as a process by which digital 3D design data is used to build up a component in layers by depositing material (from the International Committee F42 for Additive Manufacturing Technologies, ASTM). According to ASTM F2792-12a, there are seven categories of AM technologies: binder jetting, directed energy deposition, material extrusion, material jetting, powder bed fusion, sheet lamination, and vat photopolymerization.

Components or objects such as wires, meshes, foils, sheets, and other preformed materials can be embedded within plastic devices (e.g., thermoplastic or thermosetting substrates) to, for example, reinforce plastic components, create a ground plane for electronic devices, create antennas, and provide electrical insulation and integrated sensor applications. The embedding of components within 3D printed parts is often not possible because the components are often a different material than the 3D printed part, and as such there are bonding issues or delamination between the dissimilar materials.

ASTM International formed Committee F42 on Additive Manufacturing Technologies in 2009 with the mission of setting the standards for design, process, and materials with regards to Additive Manufacturing (AM). The committee defined a taxonomy of seven sub-technologies that together constitute the full landscape of additive manufacturing techniques. The seven technologies are described in ASTM F2792-12a, the details of which are summarized herein.

Material extrusion is an additive manufacturing process where material is selectively dispensed through an extrusion nozzle. The most common implementation of this method involves the extrusion of thermoplastic material through a heated orifice. The materials available for the most common implementation tend to be functional thermoplastics, which are generally robust enough to withstand harsh environments such as chemical, mechanical, or temperature exposure. Material extrusion processes are office friendly (i.e., office electrical, no vacuum processing, innocuous spooled thermoplastic feedstock). The drawbacks of the technology tend to include minimum feature size dictated by the extrusion nozzle size and surface finish as well as mechanical strength anisotropy.

Vat photo polymerization features a vat of liquid photo curable polymer that is selectively cured with an energy source such as a laser beam or other optical energy like a projection system. The part under fabrication is typically attached to a platform that descends one cure depth after a layer is completed and the process is repeated. This class of additive manufacturing benefits from feature sizes dictated by either the laser beam width or optical resolution in the X and Y axis and minimum cure depth in Z axis. The advantage of this technique includes exceptional surface finish and minimum feature size dictated by optics. The drawbacks include post cleaning of liquid uncured materials and the build materials are relegated to photochemistry, which may continue to cure when subjected to UV radiation.

Powder bed fusion processes include selectively melting or sintering a layer of powder using an energy source such as a laser or electron beam, lowering the layer by a fabrication layer thickness, and adding a new powder layer by delivery with a rake or roller from gravity-fed bin serving as a material storage mechanism. The process continues with the next layer. Unmelted powder in the bed acts inherently as support material for subsequently built layers.

Advantages of this technology include feature sizes determined by the energy source and the powder size, which are relatively good, the reduction of z-strength anisotropy, and the availability of functional materials (e.g., nylons, titanium). A disadvantage of this approach includes powder waste and post-build cleaning.

Material jetting uses ink-jetting technology to selectively deposit the build material with a cure prior to the application of subsequent layers. An exemplary version of this technology may be ink-jetting multiple photo-curable polymers and follow the inkjet head with a UV lamp for immediate and full volume curing. With multiple materials, fabricated items can be multi-colored or materials can be chosen with varying stiffness properties. Ink-jetting is also naturally well suited for parallelism and thus can be easily scaled to larger and faster production. Ink-jetting also provides exception spatial resolution. Material jetting of photo-curable polymers is relegated to the photochemistry and the associated materials limitations.

Binder jetting includes selectively ink-jetting a binder into a layer of powder feedstock. Additional powder material is then dispensed from a material storage location by a rake or roller mechanism to create the next layer to create a green body. Some binder jetting technologies may require a post-anneal furnace cycle depending on the materials being used (e.g., metals, ceramics). One approach may involve inserting inkjet color (much like a commercial inkjet color printer) in addition to the binder into a powder, and may therefore provide structures with colors throughout the structure for conceptual models. Another binder jetting system may utilize a post anneal process to drive out the binder to produce metal or ceramic structures, but these structures often require an additional infiltration stage to fill in the resultant porosity and provide fully dense parts.

Sheet lamination is another additive manufacturing process in which individual sheets of material are bonded together to form three-dimensional objects. With sheet lamination, sheets of metal can be bonded together using ultrasonic energy. This process has been shown to produce metallurgical bonds for aluminum, copper, stainless steel, and titanium. A subsequent subtractive process between layers adds internal structures and other complex geometries impossible with conventional subtractive manufacturing processes that start from a billet of material. Other versions of this technology include paper and polymer sheets with adhesives. One disadvantage of this technology is the waste due to the subtractive processing.

Directed energy deposition is another additive manufacturing process that directs both the material deposition and the energy source (typically a laser or electron beam) at the surface being built. Directed energy deposition processes typically use powder or wire-fed metals and one exemplary application of the process may include repair of high value components used in aircraft engines by blowing powder coincident with a laser beam at the surface where material is being added. This technique is known for providing low rates of materials deposition, but at high spatial resolution.

Another prior art approach involves the use of a large evacuated chamber and a gantry to feed a metal filament to the surface of a metal structure under fabrication. An electron beam can be focused coincident to the surface and the contacting wire filament—melting additional material to the surface. This technique is known for providing high rates of materials deposition, but at low spatial resolution.

Components can be embedded via several methods, such as, for example, ultrasonic embedding, thermal energy, joule heating, and by the use of adhesives. Several of these methods have been disclosed by one or more of the present co-inventors in the following prior patent application publications, which are incorporated herein by reference in their entirety: U.S. Patent Application Publication No. 2013/0170171 entitled “Extrusion-Based Additive Manufacturing System for 3D Structural Electronic, Electromagnetic and Electromechanical Components/Devices,” which was published on Jul. 4, 2013 to Wicker et al.; and U.S. Patent Application Publication No. 2014/0268604 entitled “Methods and Systems for Embedding Filaments in 3D Structures, Structural Components, and Structural Electronic, Electromagnetic and Electromechanical Components/Devices,” which published on Sep. 18, 2014 to Wicker et al.

### SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for an improved apparatus, method, and system for configuring 3D structures and 3D structural electronic, electromagnetic, and electromechanical components and devices.

It is another aspect to provide an improved apparatus, method, and system for embedding a component (e.g., wires, meshes, foils, sheets, and other preformed materials) for use with 3D structural electronic, electromagnetic, and electromechanical components; to protect such components from oxidation, provide electrical insulation or conduction between electrical components and interconnections; additionally, increase the environmental durability of such components (e.g., protection from oxidation, UV exposure, humidity, contain a corrosive inhibitor, etc.); and even further, provide a means for securing the component and allowing the component to be secured (adhered) to the substrate material in which it is placed and on which new substrate material is deposited and potentially improving the surface energies at the material interfaces.

The aforementioned aspects and other objectives and advantages can now be achieved as described herein. An embedded material, and an embedding apparatus, system and method are disclosed. A compatible solute (e.g., which can include a plastic, metal, or glass) can be dissolved in a compatible solvent. Note that the term “compatible solvent” as utilized herein means not only is the solvent solution compatible with the extruded plastic from the 3D printer, but also with the object being coated. Additionally, the “compatible solute” material is miscible with the 3D printing material and component to be embedded as well as with the solvent. That is, the solute and solvent both must be compatible with one another, the object to be embedded, and with the 3D printing material.

The disclosed approach to creating a coating can include other polymerization processes, for example, emulsion polymerization, catalytic homopolymerisation (e.g., such as with cross-linking epoxies). With regard to two part epoxies, the extruded plastic from a 3D printer can be placed on the two-part epoxy before or after curing (or hardening). A preferred process involves addition and condensation polymerization. Other coating materials can include, for example, Incralac (a solvent-based, air drying acrylic resin), fluoropolymers, and polyurethane resins (e.g., if a scratch resistant surface is desired). The polymerization will also help with difference of the coefficient of thermal expansion between the component/object and the 3D printed plastic.

The object to be embedded can be coated with the solution or in some situations an adhesive may be employed. Preferably, as indicated previously, a solvent based coating, epoxy resin, or condensation process can be utilized. Note that the coating can be on a region of the object or component, or can fully encapsulate the object/component, including internal cavities. In some embodiments, particles or chemicals can be introduced into the solution. For example, a corrosion inhibitor, such as benzotriazole may be employed. Such particles can serve to create a texture and/or surface energies that are beneficial for adhering the extruded 3D printing plastic onto the textured coating.

In some example embodiments, the solvent (e.g., acetone) can be removed through air drying, heating the solution, or any other method by those skilled in the art, until all solvent is removed. A benefit accrues from removal of the solvent before placing back in the printer. That is, if the solvent is still in the coating during the printing process, the evaporation of the solvent will distort and degrade new (and previously) printed structures. This will create a final part with poor dimensional accuracy and mechanical properties.

In other example embodiments, however, the solvent may not need to be removed. In some cases, for example, water can be a solvent. In that case, the part may be introduced into the printer before all solvent is removed, as the water will evaporate within the printer (as long as the thermodynamic conditions (pressures, temperature, humidity) in the printer allow the evaporation of the solvent). Note, however, that is not necessary to be at the boiling point to evaporate the water.

The coated object can be inserted into the partially 3D printed substrate and the interrupted 3D printing process can be resumed in order to fully embed the coated part within the substrate. Alternatively, the object to be embedded can be coated with molten plastic (compatible with the 3D printing process). The coated object can be inserted into the partially 3D printed substrate and the interrupted 3D printing process can be resumed in order to fully embed the coated part within the substrate.

The coating of the inserted object as well as the insertion of the object can be integrated outside or inside the 3D printing machine (as the 3D printing machine can act as a heating source to evaporate all or part of the solvent). The coating within the machine can provide a critical role when the desire is to create intimate contact between multiple components (e.g., between heat generating electronics and copper foil heat sink). The item to be embedded may (or may not) undergo a surface preparation (e.g., cleaning, etching) prior to the coating process. Additionally, this cleaning process may (or may not) be automated by the embedding system.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the principles of the disclosed embodiments.

FIG. 1 illustrates a flow chart depicting operational steps of an embedding method, in accordance with a preferred embodiment;

FIG. 2 illustrates a flow chart depicting operational steps of an embedding method, in accordance with an alternative embodiment; and

FIGS. 3-4 show an example of an extrusion-based additive manufacturing system for 3D structural electronic, electromagnetic, and electromechanical components/devices, which can be adapted for use in accordance an example embodiment.

### DETAILED DESCRIPTION

The particular values and configurations discussed in these non-limiting examples can be varied and are cited merely to illustrate at least one embodiment and are not intended to limit the scope thereof.

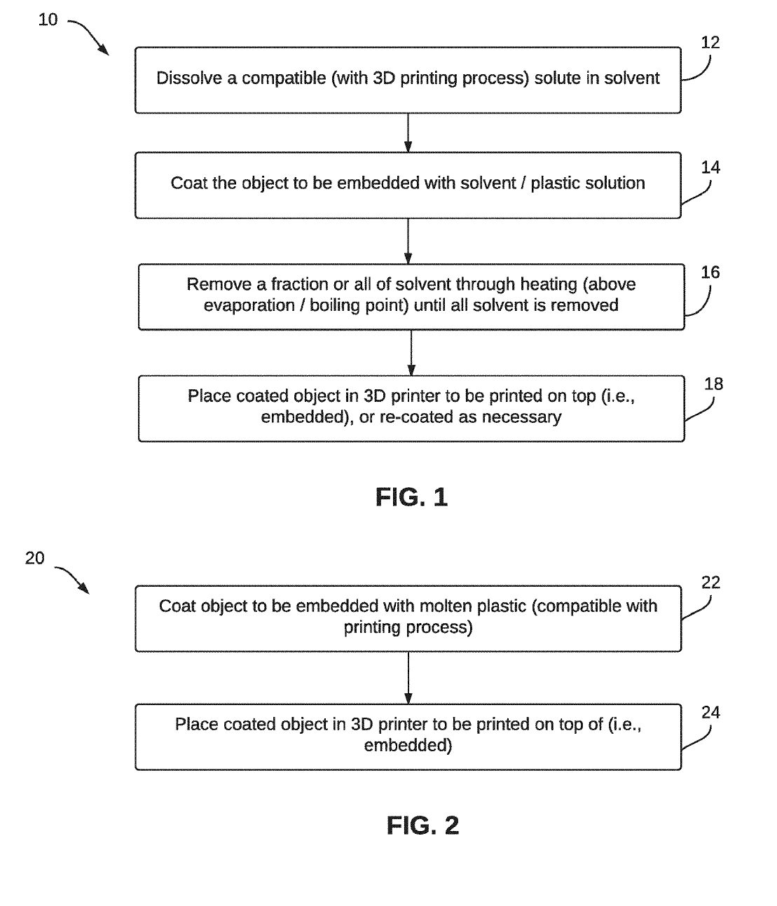

FIG. 1 illustrates a flow chart depicting operational steps of an embedding method 10, in accordance with a preferred embodiment. As shown at block 12, a step can be implemented to dissolve a compatible solute in a solvent. Thereafter, as depicted at block 14, a step can be implemented to coat the object or component with the solution. Examples of such an object/component include items such as foils, wires, sheets, 3D printed metallic elements, meshes, ceramic elements, 3D printed ceramic elements, and other polymeric structures (3D printed and otherwise). Anything that can survive either a molten plastic or solvent evaporation process constitutes a “component” or “object” as utilized herein.

As illustrated next at block 16, a step can be implemented to remove a fraction or all of the solvent through, for example, air drying, heating the solution, or any other appropriate method, until all the solvent is removed. The process will also work if there is a small fraction of solvent left in the object. As indicated next at block 18, a step can be provided to place the coated object in the 3D printer to print on top of (i.e., embedded) or re-coat as necessary. Note that in some embodiments, the object can be coated multiple times before placing the object in the 3D printed part.

Thus, in the embodiment shown in FIG. 1, a component can be embedded within a polymer by using a solution that creates a coating on the component. For example, a component such as a section of wire mesh can be coated using addition and/or condensation polymerization and/or embedded within ABS or polycarbonate using an ABS/acetone solution. The solvent can then be removed via evaporation, for example, to prevent the solvent from damaging proximate components. Removal of the solvent can involve heating the solvent to above the evaporation or boiling point.

Note that although some embodiments can be implemented in the context of material extrusion additive manufacturing, the approach described herein can apply equally to powder bed fusion processes, sheet lamination, material jetting, binder jetting, directed energy deposition, vat photopolymerization, as well as other non-3D printed technologies. It can be appreciated that the disclosed approach can be implemented in a variety of areas and therefore the scope of this disclosed embodiments should not be limited by the specific examples described herein.

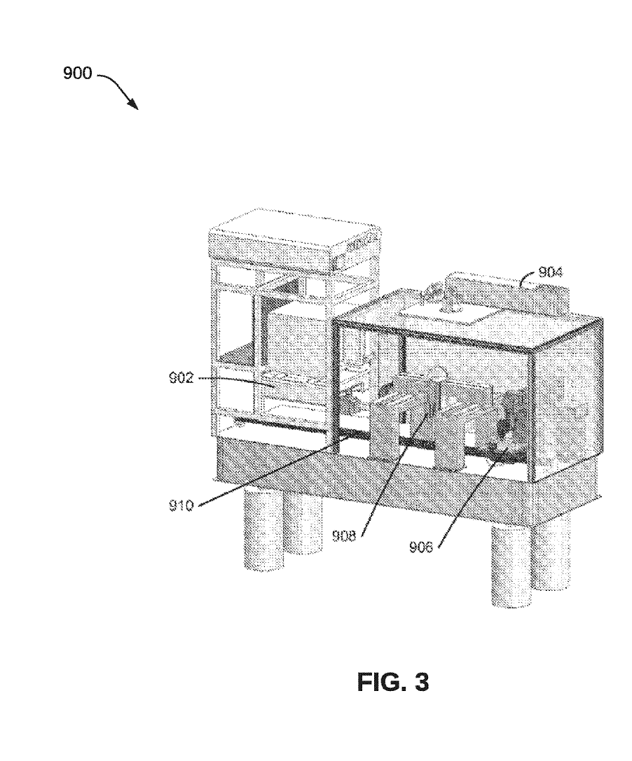

FIG. 2 illustrates a flow chart depicting operational steps of an embedding method 20, in accordance with an alternative embodiment. As indicated at block 22, the object can be coated with molten plastic (compatible with the 3D printing process). Then, as indicated at block 24, a step can be implemented to place the coated object in the 3D printer to be printed on top of (i.e., embedded).

Note that in some embodiments, an epoxy polymer can be used to coat at least one of a planar and/or non-planar surface prior to embedding with the object. The object may include, for example, a planar surface or a non-planar surface depending on design considerations. As indicated previously, other coating materials can include, for example, Incralac (solvent-based, air drying acrylic resin), fluoropolymers, and polyurethane resins (e.g., if a scratch resistance surface is necessary).

Utilizing an object or component such as those described herein can allow for the embedding, accurate placement, and printing on of fully dense structures (e.g., copper sheet, micro-machined plane, and other non-planar material). Employing the solvent coating and addition and/or condensation polymerization methods described herein can result in the accurate placement of fully dense structures or objects (e.g., wires, meshes, etc.) within a 3D printed part. The disclosed embodiments can be used to embed and print on objects created with metal, three-dimensional printing. The solution can be used to embed the object as long as the solute can withstand the vaporization temperature of the solvent and the 3D printing polymer does not react with the chemical.

Note that in some embodiments, the coating application process can be automated wherein the material to be coated is cleaned (or not), etched (or not), polished (or not), or undergo other cleaning process (or not), as mandated by the material system to be embedded. The solution, molten material, or other coatings can then coat the material. Cleaning processes can include (but are not limited to) chemical pretreatment in alkaline solutions, use of degreasing inorganic solvents, and/or electrolytic degreasing in alkaline solutions.

In other embodiments, a material or piece can be coated in a molten or flowing plastic (e.g., heated beyond its glass transition temperature or melting temperature depending on the plastic material) followed by embedding of the object material. For example, Acrylonitrile Butadiene Styrene (“ABS”) can be melted onto the component in this matter with a 3D printed layer later printed on top of the ABS/embedded object system. Note also that in some embodiments, the coating can be integrated outside or inside a 3D printing machine because the 3D printing machine is capable of functioning as a heating source to evaporate all or part of the solvent. The disclosed process and variations thereof can thus be performed inside and outside of a 3D printer.

Benefits of the disclosed embodiments include, for example, the prevention or limitation of oxidation along with the coating containing chemical additives (e.g., the corrosion inhibitor benzotriazole). Another benefit involves printing over the top of the epoxy/silicon/polymer-coated material and a more accurate Z-height embedding feature along with a more exact separation distance between components. The improvement in Z height (and also X-Y) is that the area where the part is embedded can be determined in the CAD file; the accuracy of this placement then becomes only a function of printer calibration and is not representative on calibration of the embedding system. An additional benefit that can result from the disclosed approach includes the creation of a waveguide for an antenna that targets predefined frequencies. Another benefit is that the “coating” described herein provides electrical isolation between components. Another advantage of the disclosed embodiments is to reduce oxidation and this could be for any metal object (e.g., mesh, wire, foils, etc.) embedded and subjected to high temperatures. That is, metal objects such as, mesh, wires, or foils can oxidize.

The disclosed embodiments offer an added benefit of reducing the oxidation of embedded components (e.g., by coating the object or component). Note that the coatings applied to the component protect that item or component from oxidation. Also, mitigating oxidation is not the only benefit. In some cases, the coated item is not prone to oxidation, but sensitive to moisture. Applying the coating to sensitive components now creates a barrier for moisture (i.e., hermeticity). For example, the coating can contain chemical additives in order to solve a specific (or multiple) failure mechanisms, such as increasing corrosion resistance. In other embodiments, the coatings can promote specific oxidation types, which may provide benefits to the system.

The coating may also contain UV absorbers, electrically conductive particles, antioxidants, chelating agents, plasticizers, leveling agents, wetting additives, and curing catalysts. Also, if there is a mismatch in coefficient of thermal expansion (CTE) between the substrate material and the item being embedded, the coating can act as an interface material that will distribute the stresses brought about by thermal expansion, which can lead to warping/deformation when there is mismatch in CTE. Depending on the material of the component to be embedded, there may be a mismatch in surface energies between the component and the material to be dispensed on top of the component during the 3D printing embedding process. This coating can further assist in the embedding process by enabling the 3D printing material to be dispensed and adhere to the component.

The disclosed approach can be employed to embed fully dense structures and is not limited to metallic elements. For example, objects constructed from: thermoplastics, thermosets, ceramics, glasses, and metals can be embedded. Embedded components can include 3D printed structures and traditionally manufactured elements. For example, ceramic must first be prepped by applying (e.g., dipping/coating) the ceramic with the solvent/solution mixture, as 3D printed polymers do not typically adhere well to ceramic materials.

It is also important to keep in mind that the component which will be embedded is treated and then placed, snapfitted, or submerged into the 3D printed structure with or without the additional use of ultrasonic embedding, thermal energy, joule heating, and/or adhesives. Also, the coating can be molten/melted plastics, partially dissolved plastics, a plastic/solvent solution (i.e., fully dissolved), powder coatings, coatings prepared in sheet/film form and attached to the surface of item, or radiation cured coatings.

The solvent can be removed from the solute any one of a number of techniques. For example, in one embodiment, a high heat for quick evaporation can be implemented to remove the solvent from the solute. In another embodiment, for example, long thermal exposure times at a lower temperature may be utilized to assist in removing the solvent from the solute. Other methods of application should include brushing, dipping, flow coating, roll coating, curtain coating, compressed air spray, airless or high pressure spray, electrostatic spray, and electrophoretic spray. Each of these techniques has a benefit for embedding specific material sets.

The object for embedding can be prepped by etching or not etching and applying (e.g., by dipping/coating, addition, and/or condensation polymerization) a solution. For example, if mesh is utilized as the component or object, the holes in the mesh can either contain coated polymer or not contain coated polymer (based on the end user's needs and preferences). Note that fully dense structures can be coated in a manner that provides environmental stability benefits, electrical isolation (when required), electrical conduction (to promote interconnects), and/or the ability to print on top. In some embodiments, it may be desirable to use a solderable adhesive to promote interconnect.

The disclosed embodiments can provide for embedding of a component in, for example, a substrate during the fabrication of a 3D printed structure that can be geometrically complex and intricate, a structural component, or a structure with embedded electronics, sensors, and actuators. In addition, the component can be embedded in multiple layers of the thermoplastic device. The disclosed embodiments can provide electrical interconnects and antennas and wave guides with conductivity and durability comparable to that of traditional printed circuit board (PCB) and wave guide technologies. Additionally, when required, the coating process described herein can provide a form of electrical isolation for interconnects and other components.

The coating can be integrated outside or inside the 3D printing machine (as the 3D printing machine can act as a heating source to evaporate all or part of the solvent). This will provide a critical role when the desire is to create intimate contact between multiple components (e.g., between heat generating electronics and copper foil heat sink). As an added benefit, the process will electrically insulate the components.

Note that the coating can improve adhesion between dissimilar materials, but this is not directly related to CTE. Distortion and warping caused by the joining of dissimilar materials is mitigated by using a coating that distributes stresses that are caused by a mismatch in CTE.

The disclosed embodiments relate to the integration of electromagentic interactions in thermoplastics-based 3D electronics systems fabricated with additive manufacturing allowing a much greater market potential for the technology. The disclosed embodiments will in the short term result in the implementation of commercially-viable, mass-customized 3D printed electronics (e.g., smart prosthetics, wearable electronics, mission specific UAVs, or satellites, etc.), thereby revolutionizing the manufacturing and distribution of electronics.

The disclosed approach involves the use of coatings on components to achieve the efficient embedding. The coatings applied to the component also protects such components from, for example, oxidation. 3D printed parts can be built to a pre-determined height, the process interrupted, and components placed, snap fit, or submerged within the plastic part with or without the use of ultrasonic embedding, thermal energy, joule heating, and/or adhesives. When the 3D printing process resumes, specifically the material extrusion additive manufacturing technology, the heated build envelope and the heated extrusion tip can cause an uncoated component to oxidize. Therefore, the coating on such components can protect against oxidation. Furthermore, any additional processing that can aid in adhesion of the embedded component in the previous and subsequent layers will improve the overall structure.

In one possible embodiment, acrylonitrile butadiene styrene resin can be partially dissolved in acetone forming a solution. The solution can then be employed to coat a fine pitch copper mesh (e.g., 200×200 mesh size). The copper mesh coated with ABS/acetone solution is then rapidly heated (e.g., to 400° C. in approx. 30 seconds) in order to remove the solvent (e.g., acetone) from the ABS/acetone coating. The coated mesh can then be placed in a preprinted polycarbonate cavity, and the 3D printing process is resumed with printing of polycarbonate on both the previously printed structure and the coated mesh material. In this case, the ABS coating is compatible with polycarbonate, allowing the printed polycarbonate to adhere to the coated mesh. In general, other solvents, materials to coat, 3D printed materials, processing times, and heating temperatures can be used to accomplish this same process.

In another embodiment, acrylonitrile butadiene styrene resin can be completely dissolved in acetone forming a solution. The solution can then be utilized to coat a copper foil tape (1.5 mi1 thick copper and 1.5 mi1 thick adhesive), also known as EMI shielding tape, where the one side of the tape is pre-coated with a conductive adhesive and the solvent/ABS solution is used to coat the second side. The coated conductive foil is heated to 110° C. for 5 minutes to remove all of the acetone from the acetone/ABS coating (higher heating will damage the conductive adhesive). The conductive adhesive can then be employed to bond a 3D printed ABS substrate to the coated foil tape. The foil tape can then be patterned (inside or outside of the 3D printer) using a computer numeric control (CNC) router with micromachining capabilities to selectively remove conductive material. This allows for the accurate formation or conductive structures, such as (but limited to) waveguides, antenna patterns, and interconnects. Printing can then be resumed on the coated and patterned foil. During printing, the ABS coating provides a means for newly printed ABS to adhere to the copper foil. In general, other solvents, materials to coat, 3D printed materials, processing times, and heating temperatures can be used to accomplish this same process.

Mitigating oxidation, however, is not the only benefit. In some example cases, the coated component or item may not be prone to oxidation, but is sensitive to moisture. Applying the coating to sensitive components can create a barrier for moisture (i.e., hermeticity). The coating can also protect against UV exposure and corrosive chemicals. A benefit of this coating is to allow/enable a component to adhere to the substrate material by improving the surface energies at the materials interface. The disclosed approach provides many benefits to the 3D printing process; primarily the coating allows additional 3D printed layers to adhere to the embedded component. This process allows for fully encapsulated embedded components, as well as, quality 3D printed structure on layers above the embedded component.

Also, if there is a mismatch in coefficient of thermal expansion (CTE) between the substrate material and the item being embedded, which is often the case when there is a plastic-metal or plastic-ceramic interface, the coating can act as an interface material that will distribute the stresses brought about by thermal expansion. If not distributed, the stresses can lead to warping/deformation when there is a mismatch in CTE. This method can be used for any of the 3D printed technologies described below as well as other non-3D printed technologies. This approach can be employed in a variety of areas and therefore the scope of these disclosed embodiments should not be limited by the specific examples described herein.

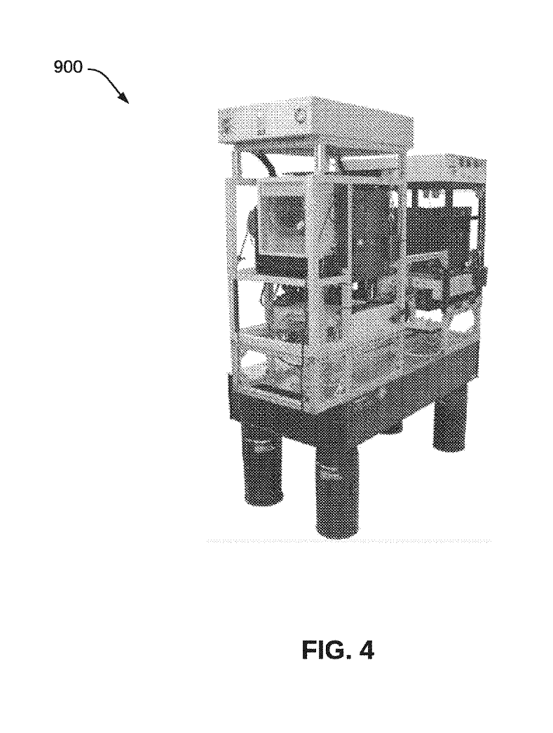

FIGS. 3-4 show an example of an extrusion-based additive manufacturing system 900 for 3D structural electronic, electromagnetic, and electromechanical components/devices, which can be adapted for use in accordance an example embodiment. The extrusion-based additive manufacturing system 900 can in some cases include a laser ablation machine 904 that removes a portion of a substrate to form a plurality of interconnection cavities and electronic component cavities within the substrate, a direct-write or direct-print micro dispensing machine 906 that fills interconnection cavities with a conductive material, and a pick and place machine 908 that can place one or more electronic components in the electronic component cavities. The laser 904 can also cure conductive material. In some embodiments, the system 900 can include a pneumatic slide 910 that transports the three-dimensional substrate to each machine or sub-system. All of the machines can be integrated into a single machine or similar manufacturing system or process.

Parts produced the disclosed embodiments can be employed in various applications such as, for example: 1) unmanned aerial systems (UASs) and unmanned aerial vehicles (UAVs) by providing aerodynamic parts with embedded sensors, communications, and electronics within structural components or by directly fabricating onto UAS and UAV surfaces; 2) customized, mission-specific disposable electronics; 3) truly 3D antennas and photonic devices that improve communications; 4) replacement components for virtually any electronic system on a naval vessel; 5) custom fit sailor-borne electronics and communications systems; 6) disposable floating depth-specific sensor systems; 7) biomedical devices; and 8) metamaterial structures, to name a few examples.

Based on the foregoing, it can be appreciated that a number of example embodiments, preferred and alternative, are disclosed herein. In one example embodiment, an embedding apparatus can be implemented, which includes, for example, a first material and a second material, the second material comprising at least one of: a molten polymer, a polymer fully or partially dissolved in a solvent, an epoxy, or another compatible solute, and a third material composed of a 3D printable material.

In some example embodiments, the surface of the first material surface may be unprepared or prepared for a coating process. Additionallly, in some example embodiments, a first material can be coated with a coating within the second material. In other example embodiments, the first material can contain one or more of the following: UV absorbers, electrically conductive particles, antioxidants, chelating agents, plasticizers, leveling agents, wetting additives, corrosion inhibitor, and curing catalysts. In another example embodiment, the first material may be coated with a coating within the second material utilizing addition and/or condensation polymerization.

In another example embodiment, one or more of the following can remove the solvent from the second material: air drying or heating. In another example embodiment, the first material can be coated with the second material via heating the second material beyond a glass transition temperature or the melting temperature of the second material. In another example embodiment, the first material may be coated via one or more of the following: brushing, dipping, flow coating, roll coating, curtain coating, compressed air spray, airless or high pressure spray, electrostatic spray, and/or electrophoretic spray. In some example embodiments, the coating may be composed of one or more of the following types of coatings: powder coatings, coatings prepared in sheet/film form and attached to a surface of an item; and radiation cured coatings.

In some example embodiments, the coated first material can be printed on with a third material via the 3D printing process. In yet other example embodiments, the third material can be composed of one or more of the following: a 3D printable polymer, metal, ceramic, biological material, or combinations thereof. In some example embodiments, the aforementioned object may be a planar surface or a non-planar surface. In some example embodiments, the first material can be embedded within the second material accurately at a pre-determined location within the 3D printed part. In still other example embodiments, the coating can provide one or more of the following: UV stability, electrically conductivity, dielectric isolation, antioxidation capabilities, corrosion protection, wetting capabilities, and/or other environmental protections.

In another example embodiment, the second material can act as an interface layer for mitigating and distributing stress caused by a mismatch in a thermal coefficient of expansion between the first material and the third material. In some example embodiments, the coating can be integrated outside or inside a 3D printing machine, as the 3D printing machine is capable of functioning as a heating source to evaporate all or part of the solvent.

In another example embodiment, an embedding method can be implemented, which involves steps for providing a first material and a second material, the second material comprising at least one of: a molten polymer, a polymer fully or partially dissolved in a solvent, an epoxy, or another compatible solute, and providing a third material comprising a 3D printable material. In some example embodiments, the first material surface may be unprepared or prepared for a coating process and wherein the first material is coated with a coating within the second material. In yet another example embodiment, the first material may be coated with a coating within the second material using addition and/or condensation polymerization.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

1. An embedding apparatus, comprising:
a first material and a second material, said second material comprising at least one of: a molten polymer, a polymer fully or partially dissolved in a solvent, an epoxy, or another compatible solute, and a third material comprising a 3D printable material.

2. The apparatus of claim 1 wherein a surface of said first material surface unprepared or prepared fore coating process.

3. The apparatus of claim 1 wherein said first material is coated with a coating within said second material.

4. The apparatus of claim 1 wherein said first material contains at least one of the following: UV absorbers, electrically conductive particles, antioxidants, chelating agents, plasticizers, leveling agents, wetting additives, corrosion inhibitor, and curing catalysts.

5. The apparatus of claim 1 wherein said first material is coated with a coating within said second material using addition and/or condensation polymerization.

6. The apparatus of claim 1 wherein said solvent is removed from said second material by at least one of the following: air drying or heating.

7. The apparatus of claim 1 wherein said first material is coated with said second material via heating said second material beyond a glass transition temperature or the melting temperature of said second material.

8. The apparatus of claim 1 where said first material is coated via at least one of the following: brushing, dipping, flow coating, roll coating, curtain coating, compressed air spray, airless or high pressure spray, electrostatic spray, and/or electrophoretic spray.

9. The apparatus of claim 3 wherein said coating comprises at least one of the following types of coatings: powder coatings, coatings prepared in sheet/film form and attached to a surface of an item; and radiation cured coatings.

10. The apparatus of claim 1 wherein said coated first material is printed on with a third material via said 3D printing process.

11. The apparatus of claim 10 wherein said third material comprises at least one of the following: a 3D printable polymer, metal, ceramic, biological material, or combinations thereof.

12. The apparatus of claim 1 wherein said object comprises a planar surface.

13. The apparatus of claim 1 wherein said object comprises a non-planar surface.

14. The apparatus of claim 3 wherein said first material is embedded within said second material accurately at a pre-determined location within the 3D printed part.

15. The apparatus of claim 3 wherein said coating provides at least one of the following: UV stability, electrically conductivity, dielectric isolation, antioxidation capabilities, corrosion protection, wetting capabilities, and/or other environmental protections.

16. The apparatus of claim 10 wherein said second material acts as an interface layer for mitigating and distributing stress caused by a mismatch in a thermal coefficient of expansion between said first material and said third material.

17. The apparatus of claim 3 wherein said coating is integrated outside or inside a 3D printing machine as said 3D printing machine is capable of functioning as a heating source to evaporate all or part of said solvent.

18. An embedding method, comprising:
providing a first material and a second material, said second material comprising at least one of: a molten polymer, a polymer fully or partially dissolved in a solvent, an epoxy, or another compatible solute; and
providing a third material orr prising a 3D printable material.

19. The method of claim 18 wherein a surface of said first material surface is unprepared or prepared for a coating process and wherein said first material is coated with a coating within said second material.

20. The method of claim 18 wherein said first material is coated with a coating within said second material using addition and/or condensation polymerization.
